(19) United States
(12) Patent Application Publication
(10) Pub. No.: US 2024/0028842 A1
(43) Pub. Date: Jan. 25, 2024

(54) SECURE LANGUAGE INTERPRETING SERVICE

(71) Applicant: Xiang Sheng Yan, Phoenix, AZ (US)

(72) Inventor: Xiang Sheng Yan, Phoenix, AZ (US)

(21) Appl. No.: 18/356,536

(22) Filed: Jul. 21, 2023

Related U.S. Application Data
(60) Provisional application No. 63/369,321, filed on Jul. 25, 2022.

(51) Int. Cl. G06F 40/58; H04M 3/42

(52) U.S. Cl. CPC G06F 40/58; H04M 3/42136

(57) ABSTRACT

An interpretation system determines an interpreter for a user, the interpreter comprising one or more individuals certified or qualified to interpret from a first language of the user to English language. The system may then transmit information to each of an interpreter device of the determined interpreter and a user device of the user, wherein the transmitted information is usable to initiate a HIPAA compliant direct communication channel between the interpreter device and the user device using a third-party communication service and the direct communication channel is not accessible by the interpretation system. The system may receive a first call duration from the interpreter and a second call duration from the user and may determine a final call duration based at least on the first call duration and the second call duration.

### BACKGROUND

Language interpreting, a service mandated for federally financed organizations, caters to the millions of Limited English Proficiency (LEP) individuals in the US, free of charge under Title VI of the Civil Rights Act of 1964. An LEP person, generally self-identified as not proficient in English, may require assistance from certified and qualified English interpreters during crucial interactions, such as with doctors, law enforcement, courts, financial institutions, educational institutions, and government representatives.

### SUMMARY

Interpretation services can be delivered in several formats: over the phone (OPI), through video remote (VRI), or in-person. Regulations concerning the privacy of these communications, such as HIPAA (including the HITECH Act), are imperative due to the nature of personal, confidential, or private information involved in these interactions. Such privacy adherence is often necessary, even beyond mandatory interpreting scenarios, across various sectors including travel, entertainment, telecommunications, and international businesses.

An interpreting service (e.g., a company that provides interpreting services) may provide a platform that connects hundreds or thousands of interpreters (e.g., speaking dozens or hundreds of languages) to hundreds of thousands (or more) of interpreting service users (e.g., LEPs). The service may hire “employee interpreters” with different language skills (e.g., different languages) and/or may also hire “contract interpreters” to meet the fluctuation of volume of the requested services.

An interpreting service may provide in-house privacy compliant (e.g., HIPAA compliant) communication channels for connecting or routing users requesting interpretation services to appropriate interpreters for each interpreting service. Communications may occur via in-house PBX system, in-house developed HIPAA compliant video/audio meeting system, and/or integrated HIPAA compliant video/audio meeting products from third party companies (e.g., in SaaS format). These in-house communication channels may entail extensive infrastructure (e.g., computing systems, power requirements, etc.) which may require heavy investment and/or expensive ongoing operating costs. In addition, because of touching and handling the privacy compliant information during each interpreting session, the interpreting service is regulated by the relevant privacy compliance rules (e.g., HIPAA rules in the case of health information). Thus, interpreting services may charge a high service fee (e.g., 80% to 200% or more), on top of the cost of hiring interpreters.

In view of the above, an interpreting service may provide multiple functions including: (1) Matching a user to an interpreter who speaks the language (e.g., a language request by the user); (2) Facilitating privacy compliant communication channels (e.g., HIPAA compliant in the case of health-related communications) between the user and the interpreter, and (3) Determining a duration of an interpreter service (e.g., for billing the user and paying the interpreter).

### Example System and Method

Disclosed herein are systems and methods of providing interpreter services that are more computationally efficient (e.g., reduced computer infrastructure, processing, bandwidth, storage requirements, power consumption, and the like), which may lead to significantly reduced costs. Rather than a single entity providing all of the three above-noted functions, described herein is an interpreter system directly provides a matching function (matching users to interpreters), but makes use of third party communication service for the actual interpreter services (e.g., a video or voice call between the user and the interpreter). In this way, the interpreter system is not required to implement technologically challenging and expensive privacy compliance measures, e.g., associated with a voice and/or video call between interpreters and users. In some embodiments, a duration of the interpreter services is determined based on input directly from the user and interpreter, without dependence or interaction with the third-party communication service, which further distances the interpreter system from privacy compliance requirements that may be associated with the actual communications between the user and interpreter.

As discussed herein, an interpreting system (e.g., provided by a first entity) provides a matching function (to match an interpreter to a user), while a third-party (e.g., Zoom video) provides the privacy compliant (e.g., HIPAA) communication channel and the users and the interpreters are responsible to manually record the interpreting service duration information that is used to determine a duration of the interpreting communication between the user and interpreter. Use of a third-party communication service allows the interpreting system to avoid heavy costs associated with self-developing a privacy compliant (e.g., HIPAA) communication channel or integrating a third-party communication channel's SaaS service. Determining the call duration based on input directly from the user and/or interpreter allows further isolation between the interpreting system and the third-party communication channel, allowing the interpreter system to limit or entirely avoid costly privacy compliance rules and regulations, for example, because the interpreting system is not touching HIPAA information.

### BRIEF DESCRIPTION OF THE DRAWINGS

FIG. 1 is a flow diagram illustrating example communications between an interpreter system, a user (e.g., person seeking language interpretation services), and an interpreter (e.g., person providing language interpretation services).

FIG. 2 is an example timing diagram illustrating an example of certain interactions between a user, interpreter system, and interpreter.

FIG. 3 is a flowchart illustrating one example of processes related to interactions of an interpreter system with both a user and an interpreter to facilitate a secure communication channel directly between the user and interpreter (e.g., via a third-party communication service).

FIG. 4 (including FIGS. 4A and 4B) are example user interfaces, e.g., displayed on a mobile device, showing a user device (FIG. 4A) and an interpreter device (FIG. 4B) each displaying user interfaces that may be provided by the interpretation application.

FIG. 5 (including FIGS. 5A and 5B) are example user interfaces that may be displayed in a web browser, such as a browser running on a desktop or mobile device.

### DETAILED DESCRIPTION

A low-cost business model for providing HIPAA compliant language interpreting services is disclosed here. In one embodiment, an interpreting service user (referred to herein as a “user”) logs into an interpreter application (e.g., an application provided by an interpretation system) is matched to an interpreter who speaks the language requested by the user and/or meets other criteria for providing an interpretation service (during an “interpretation call” or simply “call”).

The interpretation application then provides the user with call information that is useable to establish a communication channel (e.g., an audio and/or video conference) directly with the matched interpreter (e.g., without involvement of the interpretation service and interpreter application). The communication channel may be provided via a third-party communication service (e.g., Zoom, Microsoft Teams, GoToMeeting, etc.) using the interpreter's personal video/audio meeting link or telephone number, which allows the user to directly communicate with the interpreter outside of the interpretation service (and outside of the interpretation application running on the user device). The user and the interpreter may be responsible for recording their service duration info into an interpretation application. In some embodiment, the service (e.g., call) duration information may be double checked, validated, and/or updated based on records of a third-party communication service or product, and corrected by the application if necessary.

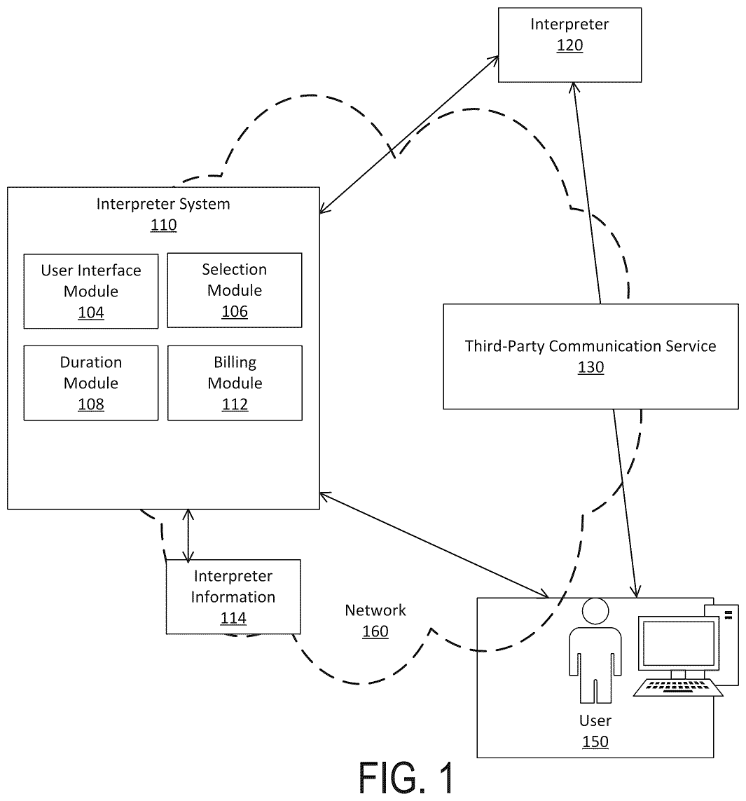

FIG. 1 is a flow diagram illustrating example communications between an interpreter system 110 (e.g., a company that provides interpreter services), a user 150 (e.g., person seeking language interpretation services), and an interpreter 120 (e.g., person providing language interpretation services). In this embodiment, the interpreter system 110 provides an interpretation service that, among other features, facilitates recording of call duration and/or other call information by the user and interpreter. An interpretation application provides interpretation services via a mobile application (e.g., via the Android or Apple store on a mobile device, or a web application in a browser), browser-based user interfaces, audio content, and/or other available content interaction formats. An interpretation application may include an application (e.g., standalone or browser-based with some or all of the code executing on a server) that is accessible by both the user and by the interpreter (e.g., the same application is downloaded from an application store and/or a same website or online portal are used by both the user and the interpreter). In this example, functionality provided to the user and the interpreter may be customized by the interpreter application, such as through settings or options that are available via interactive controls and/or that are automatically detected. In another example, the interpretation application includes a user-side interpretation application operating on the user device and an interpreter-side interpretation application operating on the interpreter device, each of which provide functionality specific to the user or interpreter, respectively. As used herein, the term “interpretation application” refers to any of these configurations of software application(s).

In some embodiments the interpretation application does not require a separate application download on a user device, but may be accessible by the user browsing to a particular URL (that includes script, e.g., JavaScript, that executes client-side (e.g., on the user device) and/or server side (e.g., on a server of the interpreter system 110 in the cloud) to perform functionality described herein.

In the example of FIG. 1, user 150 (which generally refers to a computer device and/or a human user) is in communication with an interpreter system 110 and an interpreter 120. In this example, interpreter system 110 includes a user interface module 104 that may provide user interface data and/or other information to the user 150. For example, the user interface module 104 may provide website information, such as via one or more servers that are Internet-accessible, that may be loaded in a browser of the user computing device. In some examples, the user interface module 104 may provide data to the user 150 that populates a predefined template, such as that may be displayed via an application executing on a mobile device and/or via a web browser.

In the example of FIG. 1, the user 150 accesses an interpretation application, such as by downloading an application from an online store or accessing a website via a browser (e.g., on a desktop, notebook, or mobile device). The user 150 requests an interpretation service from the interpreter system 110, which may then identify a matching interpreter 120, such as an interpreter that is fluent in the language (e.g., Spanish, French, German, American Sign Language (ASL), etc.), as well as English, requested by the user 150 and/or is available at the particular time requested by the user 150, for a particular type of task requested by the user 150 (e.g., medical, legal, etc.), and/or meets other criteria that are associated with an interpretation session that is requested by the user 150 (e.g., experience, user ratings, etc.). In the example of FIG. 1, the interpreter system 110 includes a selection module 106 that includes rules and/or other logic (e.g., models, deterministic or nondeterministic algorithms, artificial intelligence methods, etc.) for selecting an appropriate interpreter 120 to provide the requested interpretation service (e.g., interpret speech in a first language to speech in a second language that is spoken by the user during an interpretation call, such as an audio or video call).

In the example of FIG. 1, once the interpreter system 110, e.g., via the selection module 106, has selected the interpreter number 120 for servicing the interpretation request from the user 150, the interpreter system 110 provides communication link information to each of the interpreter 120 and the user 150. In some examples, the communication link is provided separately to each of the interpreter 120 and the user 150. In one example, each of the interpreter 120 and user 150 access the communication link to establish a communication channel via a third-party communication service 130. Advantageously, the communication channel between the interpreter 120 and the user 150 is not transmitted (or otherwise accessible) via the interpreter system 110. As shown in FIG. 1, the interpreter system 110 also includes a duration module 108, which is configured to determine a service duration of an interpretation call between the interpreter 120 and the user 150, e.g., where interpretation services were provided. In some examples, each of the user 150 and the interpreter 120 separately provide indications of a duration of the interpretation service directly to the interpreter system 110. The service duration info may include the start date/time, end date/time of the interpreting service, and/or other information regarding the interpretation call via the third-party communication channel. The duration module 108 may then determine a duration of the interpretation service based on the received duration information from each of the interpreter 120, user 150 and/or other sources. In one example, the call duration may be determined based on a difference between an average start time (from the user and interpreter) and an average end time (from the user and the interpreter). In another example, the call duration may be determined based on a difference between the earliest start time (between the start times provided by the user and the interpreter) and the latest end time (between the start times provided by the user and the interpreter). In another example, the call duration may be determined based on a difference between the latest start time (between the start times provided by the user and the interpreter) and the earliest end time (between the end times provided by the user and the interpreter). In other examples, other algorithms may be used to calculate call duration.

In some embodiments, reliability and accuracy of manual records may be maintained by selectively checking against third-party resources. For example, the third-party communication service 130 may provide a call history (including start date/time and end date/time and/or duration) to the duration module 108, which may be used to validate and/or modify a call duration that would otherwise be determined by the duration module 108. Based on the call duration determined by the duration module 108, a billing module 110 may determine and/or initiate invoicing the user 150 and/or paying the interpreter 120.

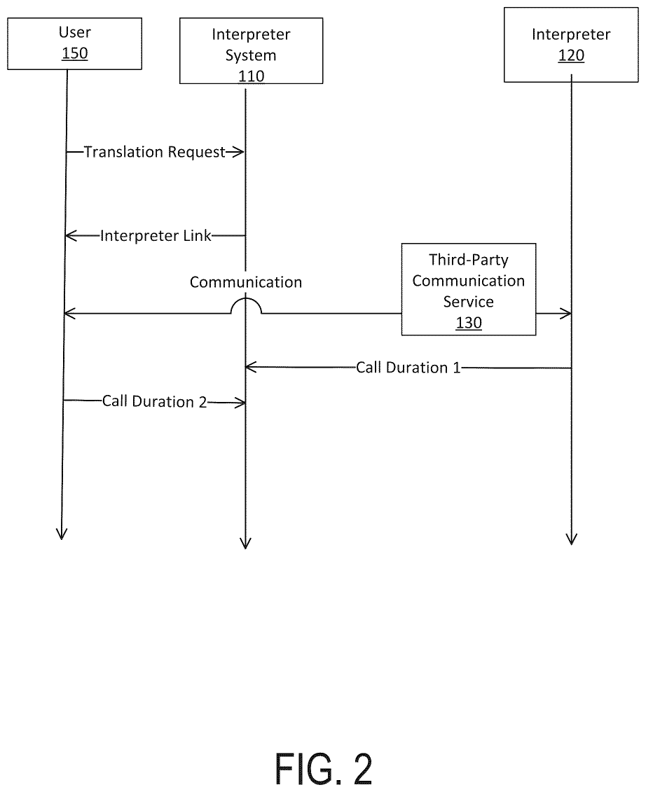

FIG. 2 is an example timing diagram illustrating an example of certain interactions between a user 150, interpreter system 110, and interpreter 120. In other embodiments, additional, fewer, and/or different processes may be performed by one or more of the devices.

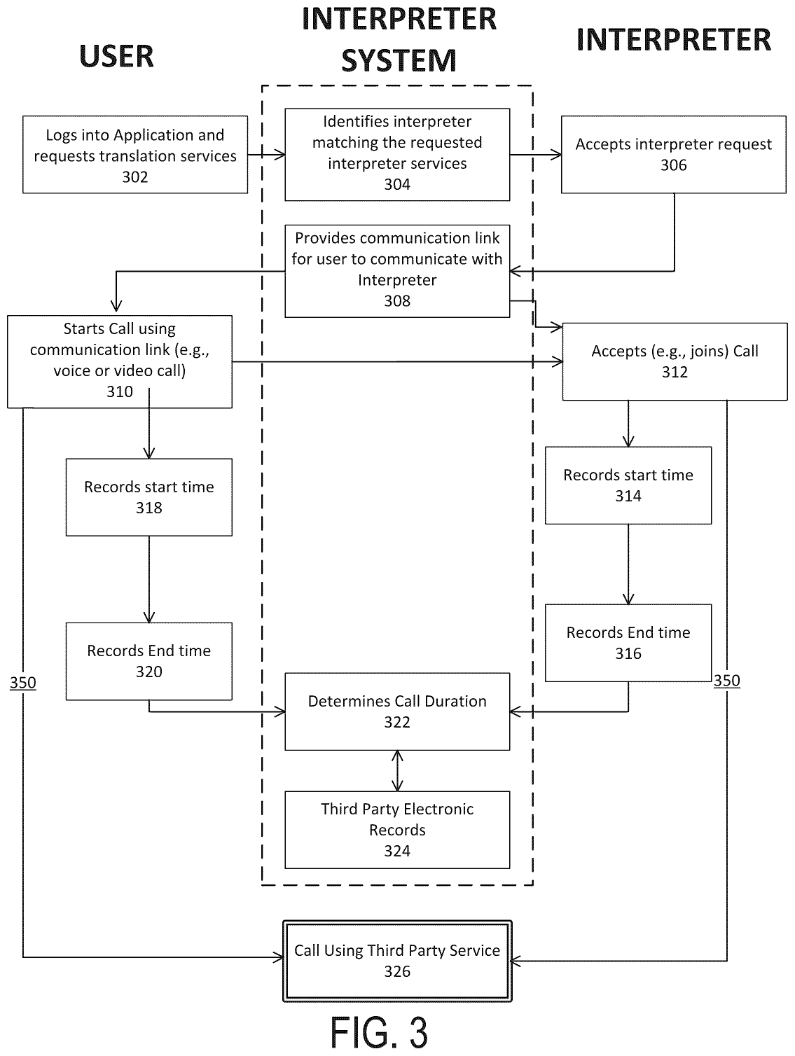

FIG. 3 is a flowchart illustrating one example of processes related to interactions of an interpreter system with both a user and an interpreter to facilitate a secure communication channel directly between the user and interpreter (e.g., via a third-party communication service). Depending on the embodiment, the process discussed with reference to FIG. 3 may include fewer and/or additional blocks and/or the blocks may be performed in an order different than is illustrated.

Beginning at block 302, a user logs into an interpretation application and request interpretation services. As noted above, the interpretation application may take various forms, such as a stand-alone application or a web-based (e.g., browser based) application. In some embodiments, user preferences are associated with the user, and stored either locally on the user device and/or by the interpreter system (e.g., in account data stored for the user in the cloud). For example, once a user logs in to the interpretation application, preferences, such as native language, requested language, preferred names, pronouns, etc. may be accessed and used in matching to an interpreter, establishing a secure communication channel, and/or during the interpretation call. Additionally, user preferences may store information regarding previous interpreters, including a user rating of the interpreter. Thus, in some embodiments the interpreter system may not need to perform an additional matching process initially, but may recommend to the user that a previously used interpreter (e.g., that was most highly ranked) be used for a newly requested interpretation service. In some examples, the user preferences may also store a preferred third-party communication provider.

Next, at block 304, interpreter system receives the interpretation request from the user and identifies an interpreter matching the requested interpretation services. In some embodiments, the interpreter system accesses a database of interpreter information to determine an appropriate interpreter. In some embodiments, the interpreter system may determine multiple suitable interpreters and may provide those options back to the user, such as via a graphical user interface on the user device. The user may then select one of the displayed interpreters for billing the requested interpretation service.

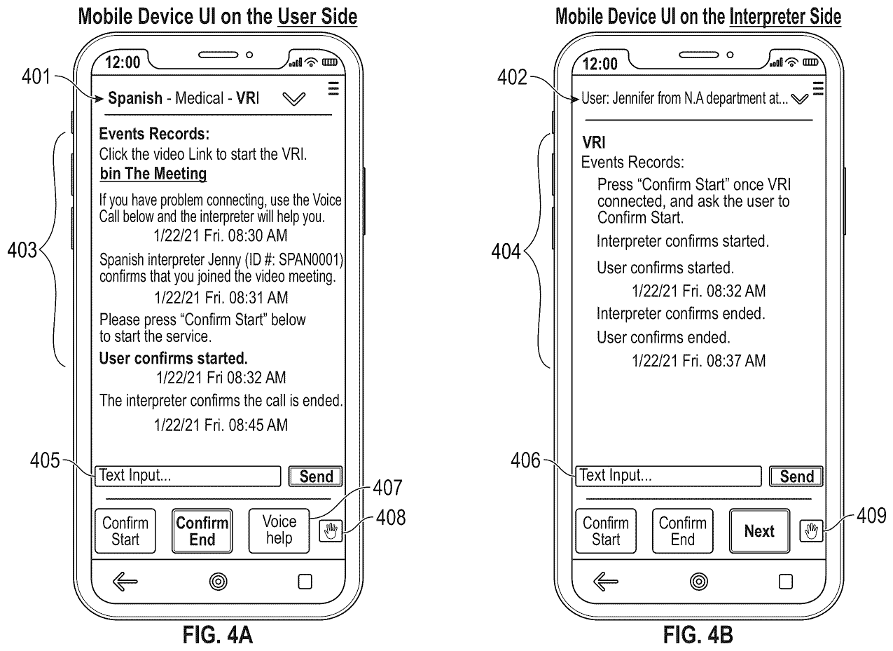

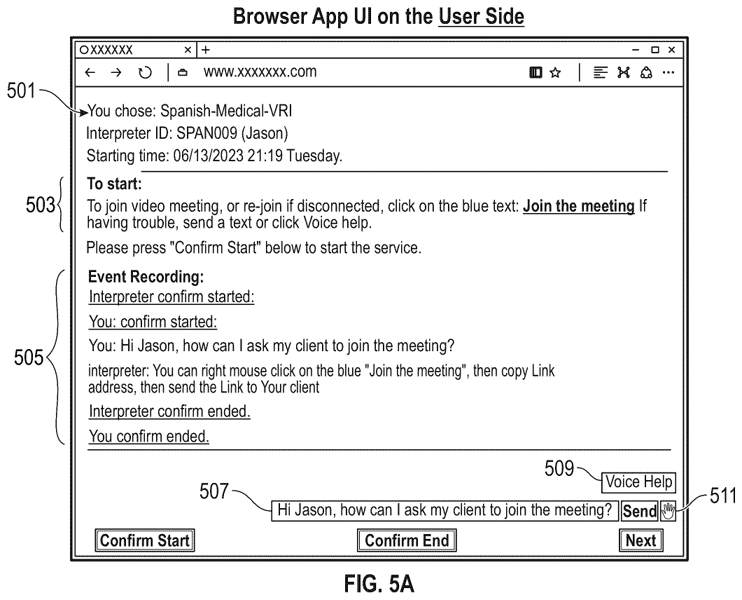

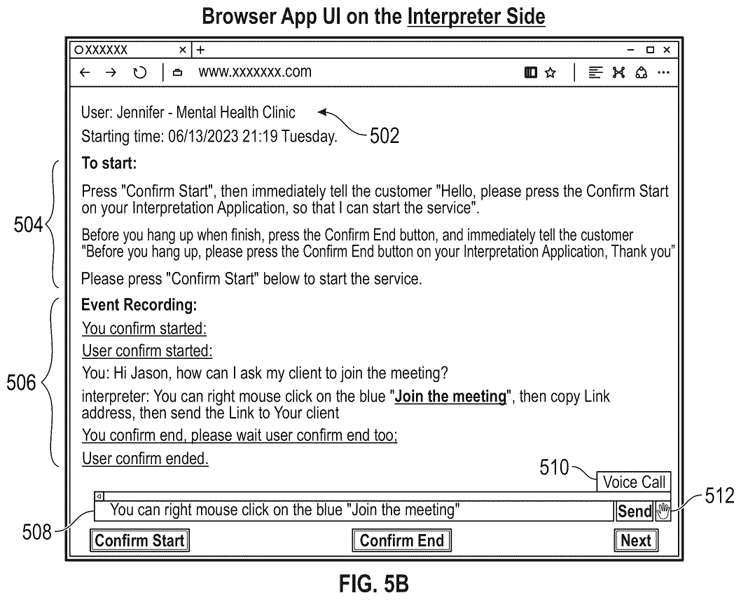

Moving to block 306, the selected interpreter receives an interpretation request from the interpreter system and may either accept the request or deny the request. If the request is accepted, a secure communication channel (provided by a third-party communication service, such as Zoom) between the user and interpreter device is established. As shown and described further with reference to FIGS. 4 and 5, the interpreter application allows communications, such as through text messages, between the interpreter and user. Thus, the user may provide a communication link to the interpreter or the interpreter may provide a communication link to the user. The communication link may include a personal meeting ID or may include a meeting ID that is generated by the third-party communication service. The example implementation illustrated in FIG. 3 shows the interpreter providing a communication link (e.g., with the interpreter's personal meeting ID) to the user via the texting function of the application. The user may then activate the communication channel by selecting the communication link. While FIG. 3 illustrates this one example implementation, other embodiments of establishing a secure communication channel may also be used in place of blocks 308, 310, 312, for example.

In the example of FIG. 3, at block 308 the interpreter system (e.g., via a texting function of the application executing on the interpreter and user devices) provides a communication link of the interpreter (e.g., including a personal meeting ID of the interpreter) to the user. As noted above, in another example a communication link of the user (e.g., including a personal meeting ID of the user) is provided by the user via the application. In some implementations, the personal meeting ID of the interpreter (and/or user) is stored by the interpreter system. In this implementation, the interpreter system may provide the communication link with the interpreter's personal meeting ID to the user (without requiring the interpreter to separately send the communication link via the texting function of the application). In other embodiments, the communication link may be shared and/or otherwise provided to each of the user and the interpreter in any other manner. In any case, the communication link establishes a secure communication channel (between the interpreter device and user device) that the interpreter system is isolated from.

Next, at block 310 the user starts an interpretation call (e.g., which generally refers to a video call, audio call, text-based call and/or any other type of communication) using the communication link. At block 312, the interpreter joins the call to establish a secure communication channel 350 via the third-party communication service 326. Advantageously, the communication channel 350 (e.g., the video call) is physically isolated from the interpreter system.

At blocks 318 and 314 the user and the interpreter, respectively, record a start time of the call, and then at blocks 320 and 316, the user and interpreter, respectively, record an end time of the call. In some embodiments, the indications of the start and end of a call are performed first by the user, which triggers a request to the interpreter to indicate the respective start or end of the call. In other examples, the indications of the start and end of a call are provided first by the interpreter, which triggers a request to the user to indicate the respective start or end of the call.

Next, at block 322, the interpreter system receives the call information (e.g., the start and end time of the call from each of the user and the interpreter) and determines a call duration. In some embodiments, interpreter system accesses third-party electronic records 324 to validate and/or update a call duration.

FIG. 4 (including FIGS. 4A and 4B) are example user interfaces, e.g., displayed on a mobile device, showing a user device (FIG. 4A) and an interpreter device (FIG. 4B) each displaying user interfaces that may be provided by the interpretation application. In some embodiments, the interpretation application used by the user and by the interpreter are different applications, such as a user-side interpretation application that is provided to the user and an interpreter-side interpretation application that is provided to the interpreter. In other embodiments, a same interpretation application is provided to both the user and the interpreter, and a role or functionality of the interpretation application is manually or automatically determined. In the embodiment of FIG. 4, the provided user interfaces may be displayed in the interpretation application after the user is matched with the interpreter and before they start the interpreting service through the isolated communication channel.

On the user side interface (e.g., FIG. 4A), the top part 401 shows the relevant information of the interpreter that the user is talking to. On the interpreter side interface (FIG. 4B), the top part 402 shows the relevant info of the user that the interpreter is talking to.

The example text input box 405 on the user side and text input box 406 on the interpreter side allow them to communicate with each other, such as when they have problems connecting to each other through the isolated communication channel. This text communication may not be HIPAA compliant so this text input box 405 should not be used by either the users or interpreters to transmit any HIPAA info.

The example Voice Help button 407 on the user side is a non-HIPAA compliant voice call function to allow the user to call the interpreter (e.g., in VoIP format) and ask for the interpreter's help, such as when the user has a connecting problem in using the isolated communication channel.

The example communications associated with 405, 406, 407 are text and voice communications specifically designed to assist the user to gain access to the isolated communication channel with the interpreter side's help. Because the interpreter system cannot “see” or access the isolated communication channel at all due to the physical isolation, and hence cannot provide help directly. Rather, the convenient menu and functions for the interpreters to quickly access a knowledge base provided by the interpreter system, and to provide help to the user side for any communication channels related issues.

The example ‘raise your hand’ button 408 on the user side and ‘raise your hand’ button 409 on the interpreter side may be used to report to the interpreter system any abnormal or misuse or abuse of the system during the interpretation call. The report may be in text format and may be recorded into the database together with the user ID, interpreter ID, date/time with time zone, transaction ID, etc for investigation.

In some embodiments, the text input box 405 on the user side may also be a great place to allow users to use any of their own preferred Telehealth tools. All the user side has to do is to just copy and paste into text input box 405 their own Telehealth meeting link, which is shown to the interpreter side application, and the interpreter simply clicks the link to join the Telehealth meeting initiated by the user. In this example, the Interpreter system does not need to integrate any Telehealth tools (or third-party communication service) because the user can use any Telehealth tools as the communication channel.

FIG. 5 (including FIGS. 5A and 5B) are example user interfaces that may be displayed in a web browser, such as a browser running on a desktop or mobile device. FIG. 5A illustrates an example user device and FIG. 5B illustrates an example interpreter device. Each of the user and interpreter devices may execute the same web application (e.g., via a website URL) or may execute web applications that are specific to the client or interpreter tasks to be performed. In this example, a voice call may be coordinated by the interpretation application (as the isolated communication channel), but in other embodiments a video call could be chosen by the user (or as an application default) to coordinate a video call. In some examples, a web-based interpretation application may be much lower size (e.g., less than 1 MB size) than a standalone interpretation application (e.g., more than 50 MB), and provides users with interpretation services without needing to install a standalone application and periodically update the application. Use of a web-based interpretation application may minimize IT support that may be needed in many organizations where application installation typically requires administrator rights and special network settings and multiple levels of security checkups and approvals. In addition, the web-based interpretation application may be configured to open and run within browsers (e.g., Chrome browser) that may already be installed on mobile devices, e.g., iPad, iPhone, tablet, Android phone, Windows Phone, etc.

In the example of FIG. 5, the illustrated user interfaces may be displayed in the web application after the user is matched with the interpreter and before they start the interpreting service through the isolated communication channel.

On the user side interface (FIG. 5A), the top part 501 shows the relevant information of the interpreter that the user is talking to. On the interpreter side interface (FIG. 5B), the top part 502 shows the relevant info of the user that the interpreter is talking to. In the events recording area 505 (FIG. 5A) and 506 (FIG. 5B) certain interactions with the application and/or the other user are summarized. In this example, the recorded events are in text format underlined for easy recognition. The text without underline, sent via the text messaging function may be used to communicate information that is easier to communicate via text than via voice, e.g., a Telehealth meeting link, or multi-step instructions, etc. The area 503 on the user side acts as a reminder to users on how to start the meeting (using the third-party communication service) with the matched interpreter, how to re-join the meeting if Internet gets disconnected, how to find help from the interpreter in case the user could not connect to the Zoom meeting, and the action needed once the Zoom meeting is connected. The area 504 on the interpreter side is filled with scripts that act as a reminder to interpreters on what to tell users once the interpretation call gets connected, what to tell users right before the meeting ends, and action needed once the interpretation call is connected.

The example Voice Help button 509 on the user side, together with the voice call or answering button 510 on the interpreter side, provides a non-HIPAA compliant voice call function (e.g., in SaaS format) to allow the user to call the interpreter (e.g., in VoIP format), such as to ask for the interpreter's help regarding a technical issue with the isolated communication channel. This call functionality is useful because the interpreter system cannot “see” or access the isolated communication channel, and hence cannot provide help directly.

The example ‘raise your hand’ button 511 on the user side and ‘raise your hand’ button 512 on the interpreter side may be used to report to the interpreter system any abnormal or misuse or abuse of the system during the interpreting service. The report may be in text format and may be recorded into the database together with the user ID, interpreter ID, date/time with time zone, transaction ID, etc. for investigation.

In some embodiments, the text input box 507 on the user side may also allow users to use any of their own preferred Telehealth tools. For example, the user may copy and paste into text input box 507 their own Telehealth meeting link (e.g., using a third-party communication service), which is shown to the interpreter side UI in the interpretation application (e.g., via a browser in FIG. 5B), and the interpreter clicks the link to join the Telehealth meeting initiated by the user. Thus, in some embodiments the Interpreter system does not need to integrate any Telehealth tools because the user can still use any Telehealth tools securely via their own isolated communication channel.

Manual records may be subject to possible human error, although infrequently. Thus, the interpreter system and/or the interpreter application (provided by the interpreter system) may implement one or more of the following strategies, functions, and algorithms.
The user and/or the interpreter may be required to record the start date/time and end date/time of the interpretation service. The user side records may be used to calculate interpretation service duration info that is automatically checked against the interpreter's records (provided to the interpretation application). Unreasonable discrepancies between the user's records and the interpreter's record may trigger an investigation alert to interpreter system's supervisor.
After the interpreting service starts, e.g., immediately after starting, the interpreter may remind the user to push the “Confirm Start” button in the interpretation application, otherwise the interpreter should not start to provide the service, or the interpreter may not get paid. In some embodiments, if the interpretation application detects this type of event a warning email (or other notification) may automatically sent to the interpreter.
After the interpretation service ends, the interpreter may need to remind the user to push the “Confirm End” button in the interpretation application before hanging up (or otherwise disconnecting from the communication channel), otherwise the user may end up unnecessarily paying more than it should, such as if the interpreter pushes the “End” button later than the actual end time of the interpretation service, for whatever reasons. In some embodiments, the interpretation application may detect that the user side pushing “Confirm End” action is missing, and trigger an alert to the user or to the interpreter system's supervisor for investigation.
When the user did not push the “Confirm End” button before hanging up, the interpretation application may automatically send a warning email to the interpreter, and the interpretation application may start to automatically pop up a message “Please ask the user to push ‘Confirm End’ button before hang up” every x (e.g., 5) minutes for y (e.g., 20) continuous times on the interpreter-side interface for all the interpreting services thereafter. This pop-up message may remain until an “ok” button is selected by the interpreter to unblock the application interface. This acts as a reinforced training to the interpreters.
For most forgetful interpreters who keep missing the user side's pushing “Confirm End” actions, discipline or suspension of account for various periods or termination of account may be applied depending on the application reported data and case by case decision.
In one example, the “Confirm Start” button on the user side may only be enabled after the “Confirm Start” button on the interpreter side is pushed first. Similarly, the “Confirm End” button on the user side may only be enabled after the “Confirm End” button on the interpreter side is pushed first. This is to force the interpreter to lead the way through every interpreting service. One reason for doing so is because an interpreter uses the application frequently, typically provides dozens of interpreting services per day and is very familiar with every detail of the app; while a user uses the application sparsely, typically uses the interpreting service only once in a few days on average.
The user side can still manually type in “Confirm End” or similar words into text box (405 or 507) and end the service, in case the interpreter is unable to push the “Confirm End” for whatever reason. The interpretation application is able to distinguish whether the “Confirm End” was sent from text box or from pushing the “Confirm End” button, if further investigation is needed.

### Example Handling of Possible Disputes Over the Manual Records from the Users and/or the Interpreters

In some embodiments, if manual records in the interpretation application are not complete, e.g. missing one of the four timestamps (start and end timestamps from both the user and the interpreter sides), then the interpreter system (e.g., via in-house programmed software scripts) may automatically check the in-application manual records against the call history record provided by the interpreters, who may get the records from the isolated third-party communication channels. In one embodiment, the call history records, which each indicate a time zone associated with the start and stop times, are converted to the same time zone for comparability by the in-house programmed software scripts. This can help identify and investigate potential problems with the in-application manual records in a timely manner.

For the video/audio meeting communication channels, which account for more than 80% of all the interpreting services, all the privacy compliant video meeting communication services can provide call history easily, e.g., Zoom for Healthcare, Doxy, Vsee, etc. For the telephone communication channels, which account for less than 20% of all the interpreting services, the interpreters may be urged to use phone services from privacy compliant VoIP phone providers, e.g. Zoom Phone, RingRx, RingCentral, DialPad, Vonage, etc. where the call history is also readily available.

When a dispute does arise, the interpreter system may specifically request again the interpreter to send a true copy of his/her call history (e.g., that is downloaded by the interpreter from the third-party communication service website and/or stored on the interpreter device, such as in association with the third-party communication application install on the interpreter device). If needed, an internal auditor can do a video meeting with the interpreter, and request the interpreter to share his/her computer screen to guarantee a true copy when downloading. The disputes may be solved or corrected based on the investigation. In case the user side initiated the audio/video call using their own preferred Telehealth channel, the user may be responsible to provide third party electronic records to us.

### Example Quality Assurance of Interpreters' Services

In some embodiments, the interpretation application requests the user side to give a performance rating of the interpreter each time after an interpretation service. A time duration weighted average rating of the interpreter from a wide range of users may be one of the best quality assurance methods. Note, the LEPs are typically not people who cannot speak English, but are people who cannot speak English well enough in case of critical English communications, e.g., medical terminology when visiting a medical doctor. The LEPs often understand both English and the destination languages at a certain level, and they can tell if the interpreter is doing a quality job or not. They often tell the interpreting service users directly their opinions about the interpreting service quality using their less than perfect English.

If the in-person monitoring format of quality assurance is necessary or required by regulatory bodies, the interpretation application may be configured to periodically choose a user randomly who is trying to connect to an interpreter to be monitored. Then the application asks the user to voluntarily put an interpreter trainer or auditor in a three-way communication so that the interpreter trainer can still monitor the interpreting service provided by the interpreter, still on the isolated communication channel. The application may provide and show incentive or free credit to the user on the application interface to motivate the user to do so for helping us. The incentive or free credit may be implemented and embedded in billing system of the interpreter system. Note, the interpreter trainer or auditor does not need to be an employee of the interpreter system, and could be a person from a qualified third party who specializes in providing monitoring and quality assurance of interpreter's performance as a service. In some embodiments, the interpretation application includes a portal for the third party to log in and the third party may participate in the call in the same manner as discussed herein with reference to users and interpreters. Thus, the interpretation services provided by the interpreter system may provide monitoring and quality assurance jobs without touching the isolated privacy compliant communication channels at all.

### Example Protection of Identifiable Personal Information

For the user to be able to communicate with the interpreter in a separate communication channel, the interpretation application may provide to the user the contact info of the interpreter, e.g., personal Zoom meeting link, or personal phone number. In the case that the user needs to call the interpreter's phone number, the user may see the interpreter's personal phone number, and the interpreter may be able to see the caller ID of the user too. To protect such personally identifiable information (e.g., the personal phone numbers), the interpretation application's terms and conditions may forbid any user from remembering in any format of the contact info of any interpreter when using our interpreting services, and may also forbid any interpreter from remembering in any format of the personal contact info of any user.

In some embodiments, the interpreters' personal Zoom meeting IDs are password coded, an added safety layer of the personal Zoom meeting ID. (Zoom meeting ID plus password is just an example here, other privacy compliant video meeting tools have similar functions). In case the interpreter suspects his/her personal Zoom meeting ID is known to the public, he/she can change the personal meeting password so that it makes the meeting ID known to the public essentially useless. The interpretation application allows the change of the meeting link with new passcode by interpreters, and reflects it in the application user side UI so that all future calls from the user side will use the new links.

In some embodiments, the user joins the interpreter's personal Zoom meeting, and does not need a meeting ID. In some cases, the user may invite the interpreter to join a user-initiated Telehealth audio/video meeting (with a meeting ID passcode that can protect the meeting ID from intruders, and can be changed when needed). The user can send a new or updated link in the texting area 405 in FIG. 4A on user side UI, or in the text area 507 in the FIG. 5A on user side UI, for the interpreter to join in.

In some embodiments, phone numbers or OPI (Over-Phone-Interpreting) is the communication channel. The interpretation application may be designed to remind the user to dial *67 first if the user intends to hide the caller ID, so that the interpreter won't see the caller ID, as an added safety measure. Since the interpreter system will match the interpreter to the user and will inform the interpreter to expect a call right before each call happens, the interpreter will be able to identify the hidden caller ID's call is from the user by the timing.

The interpreter's phone number may be visible to the user because in some embodiments it is always the user who makes the call. The interpretation application may include terms and conditions indicating that a user is not allowed to remember any interpreter's phone number, nor to contact an interpreter without going through interpreter system application for any interpreting service-related issues. The interpretation application may allow the interpreter to report any uninvited or unpermitted calls from any user for further investigation. Warning, discipline, or removal of a user may be triggered by our escalation system for protecting personal identifiable information, based on the frequency and number of times of violations from a specific user.

In case the interpreter still worries about that the users will know his/her personal phone number each time when an interpreting service happens over the phone for any possible reasons, he/she may be recommended or required to use the audio meeting part of a third-party communication server (e.g., the video/audio Zoom meeting tool). Another way is to offer the user side to use the “call-in toll number” to join the interpreter's personal third-party communication service (e.g., Zoom meeting), in case the user does not have a computer or internet or cell phone data but just a landline or VoIP phone. To join the interpreter's personal Zoom meeting by “call-in number”, the user calls one of the toll numbers in the US, then punches in the interpreter's personal meeting ID, then punches in a passcode to join the meeting. Again, this numeric passcode for the interpreter's personal Zoom meeting ID for “call-in number” access can be changed any time if needed. Once the interpreter changes the passcode, an intruder will not be able to connect to the interpreter's personal meeting from a landline even if the intruder knows the interpreter's personal meeting ID and previous passcode. The toll numbers+personal meeting ID+numeric passcode will be shown to the user side UI by the application when the user requests interpreting service in OPI format. The interpreter can update their personal meeting's numeric passcode in the application which will be reflected to the user side UI when the next interpreting service encounter will happen.

Personal Zoom meeting and “call-in toll number” to join a Zoom meeting mentioned above are just to give an example to illustrate the application design and strategies, and the above scenarios apply to all other HIPAA compliant communication products or channels.

### Example Further Privacy

Current existing interpreting company business models mostly, if not all, use the combination of employee interpreters and contractor interpreters to guarantee 40 to 300 language availability at all times, while being able to handle the interpreting service volume fluctuation at minimum cost. Even if the employee interpreters working for an interpretation service will be 100% working from home and all of them will have passed HIPAA compliant tests and regular auditing, it is still possible that regulatory bodies think communications needs to be regulated by HIPAA rule because those “employee interpreters” are considered as “regular” employees of the interpreter entity, hence the interpreter entity is still considered as handling HIPAA information and needs to comply with HIPAA rules and regulations.

To completely exclude the interpreter system's employees, including employee interpreters or non-interpreter employees, from touching HIPAA info, the interpreter system (e.g., and the interpreter entity that provides the interpretation application) may use only work-from-home “independent contractor interpreters” (not employee interpreters). Thus, the interpreter system may not be classified as an Interpreting Service Provider (aka ISP), but purely an online platform that connects independent interpreters with users and charge platform service fees. The actual interpreting services are provided by the interpreters to the users using a third-party communication channel directly between the interpreters and users. The independent contractor interpreters may obtain their own HIPAA compliant communication channels at their own cost.

To increase likelihood that users can find a matching independent contractor interpreter at all times as much as possible, one or more of the following features may be implemented in the interpretation application:
Incentive algorithms and mechanisms may be used to motivate the interpreters to try to work more during busy hours and try to take breaks during non-busy hours, similar to what Uber or DoorDash does to the drivers on their platforms.
The interpreter system may use an algorithm based on historical data and data analysis to predict future busy hours on a daily basis, and show the prediction on the application interface to let the interpreters better plan and prepare on a daily basis.
On the users' side, discounts may be provided for users who pre-book interpreting services so that the users can better match interpreters' available hours and this also help the interpreter system predict busy time of the day, similar to that when a guest pre-books an Airbnb host service or airline ticket.
The interpreter system may use an algorithm to promote non-busy hours to the user with higher priority when the user is doing pre-booking, so as to try to balance between the busy hours and non-busy hours.
The interpreter system may integrate a special “backup interpreter” role who only takes interpreting services when there is no regular interpreter available, but is paid some percentage (e.g., about 20%) higher than regular interpreters for every interpreter session provided. This role may be attractive to interpreters who already have a work-from-home job with flexible time, e.g., a language interpreter mostly for written translation/interpretation. The number of “backup interpreters” can be as many as 20% (or more) of the total number of regular contractor interpreters and can hugely help service interpretation requests from users during rush hours.
For rare language interpreters who may only work a few hours a day on our platform, or even a few hours a week, users may be asked to pre-book the interpreting services according to the rare language interpreters' pre-determined schedule in the application. If an interpreting service has to be pre-booked outside the interpreter's schedule, the user may be allowed to contact the interpreter if the interpreter permits the direct contacting.

### Example Implementations

Examples of implementations of the present disclosure can be described in view of the following example embodiments. The features recited in the below example implementations can be combined with additional features disclosed herein. Furthermore, additional inventive combinations of features are disclosed herein, which are not specifically recited in the below example implementations, and which do not include the same features as the specific implementations below. For sake of brevity, the below example implementations do not identify every inventive aspect of this disclosure. The below example implementations are not intended to identify key features or essential features of any subject matter described herein. Any of the example clauses below, or any features of the example clauses, can be combined with any one or more other example clauses, or features of the example clauses or other features of the present disclosure.

Clause 1. A computing system comprising: a hardware computer processor; a non-transitory computer readable medium having software instructions stored thereon, the software instructions executable by the hardware computer processor to cause the computing system to perform operations comprising: determining an interpreter for a user, the interpreter comprising one or more individuals certified or qualified to interpret between a first language and a second language; transmitting information to each of an interpreter device of the determined interpreter and a user device of the user, wherein the transmitted information is usable to initiate a HIPAA compliant direct communication channel between the interpreter device and the user device using a third-party communication service, wherein the direct communication channel is not accessible by the computing system; receiving one or more interpreting service start time from the interpreter and/or the user that are usable in determination of a call duration of a call between the interpreter and the user via the HIPAA compliant direct communication channel; receiving one or more interpreting service end time from the interpreter and/or the user that are usable in determination of the call duration; and determining the call duration based at least on: one or more of the interpreting service start times; and one or more of the interpreting service end times.

Clause 2. The computing system of clause 1, wherein the first language is English and the second language is a non-English language.

Clause 3. The computing system of clause 1, wherein the first language is sign language and the second language is verbal English.

Clause 4. The computing system of clause 1, wherein the direct communication channel comprises a voice and/or video communication channel.

Clause 5. The computing system of clause 1, further comprising: receiving, from the third-party communication service, third-party call information including one or more of a third-party start time, a third-party end time, and a third-party call duration; wherein the call duration is further based on the third-party call information.

Clause 6. The computing system of clause 1, wherein the call duration is based on an interpreting service start time from the interpreter and/or the user, and an interpreting service end time from the interpreter and/or the user.

Clause 7. A computerized method, performed by a computing system having one or more hardware computer processors and one or more non-transitory computer readable storage device storing software instructions executable by the computing system to perform the computerized method comprising: providing an application to a user device and to an interpreter device, wherein the application is a standalone-application or a browser-based application; receiving, via the application running on the user device, an interpretation request including an indication of a requested language; accessing an interpreter database indicating a plurality of interpreters and associated languages spoken by each of the plurality of interpreters; identifying an interpreter of the plurality of interpreters as matching the interpretation request at least based on association of the interpreter with the requested language in the interpreter database; providing an interactive user-interface function enabling communication of a communication link between the user device and the interpreter device of the identified interpreter, wherein the communication link is associated with a third-party communication service and is usable to establish a direct communication channel between the user device and the interpreter device; receiving one or more interpreting service start time from the interpreter and/or the user that are usable in determination of a call duration of a call between the interpreter and the user via the HIPAA compliant direct communication channel; and receiving one or more interpreting service end time from the interpreter and/or the user that are usable in determination of the call duration.

Clause 8. The computerized method of clause 7, wherein the communication link includes a personal meeting ID of the user, and wherein the communication link is transmitted from the user device to the interpreter device via the communication functionality of the application.

Clause 9. The computerized method of clause 7, wherein the communication link includes a personal meeting ID of the interpreter, and wherein the communication link is transmitted from the interpreter device or the interpreting system to the user device via the communication functionality of the application.

Clause 10. The computerized method of clause 7, wherein the communication link includes a meeting ID generated by the third-party communication service.

Clause 11. The computerized method of clause 7, wherein the communication link includes a telephone number.

Clause 12. The computerized method of clause 7, wherein the spoken languages include sign language.

Clause 13. The computerized method of clause 7, further comprising: determining the call duration based at least on: one or more of the interpreting service start times; and one or more of the interpreting service end times.

Clause 14. The computerized method of clause 7, wherein the interpreter device is configured to execute the application on the interpreter device to: send information to and receive information from the application executing on the user device; receive input, via a graphical user interface of the application, indicating the interpreting service start time from the interpreter; receive input, via the graphical user interface of the application, indicating the interpreting service end time from the interpreter; and transmit, to the computing system, one or more of the interpreting service start time and the interpreting service end time.

Clause 15. The computerized method of clause 7, wherein the user device is configured to execute the application on the user device to: send information to and receive information from the application executing on the interpreter device; receive input, via a graphical user interface of the application, indicating the interpreting service start time from the user; receive input, via the graphical user interface of the application, indicating the interpreting service end time from the user; and transmit, to the computing system, one or more of the interpreting service start time and the interpreting service end time.

Clause 16. The computerized method of clause 7, wherein the direct communication channel is provided via a video conferencing application, an audio conferencing application, or a phone system.

Clause 17. The computerized method of clause 7, wherein, the third-party communication service is provided via a communication application downloadable from an application store on a smartphone or smart device.

### ADDITIONAL IMPLEMENTATION DETAILS AND EMBODIMENTS

Various embodiments of the present disclosure may be a system, a method, and/or a computer program product at any possible technical detail level of integration. The computer program product may include a computer readable storage medium (or mediums) having computer readable program instructions thereon for causing a hardware computer processor to carry out aspects of the present disclosure.

For example, the functionality described herein (such as with reference to an interpreter system or an interpretation application) may be performed as software instructions are executed by, and/or in response to software instructions being executed by, one or more hardware processors and/or any other suitable computing devices. The software instructions and/or other executable code may be read from a computer readable storage medium (or mediums).

The computer readable storage medium can be a tangible device that can retain and store data and/or instructions for use by an instruction execution device. The computer readable storage medium may be, for example, but is not limited to, an electronic storage device (including any volatile and/or non-volatile electronic storage devices), a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a solid state drive, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions (as also referred to herein as, for example, “code,” “instructions,” “module,” “application,” “software application,” and/or the like) for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Java, C++, or the like, and procedural programming languages, such as the “C” programming language or similar programming languages. Computer readable program instructions may be callable from other instructions or from itself, and/or may be invoked in response to detected events or interrupts. Computer readable program instructions configured for execution on computing devices may be provided on a computer readable storage medium, and/or as a digital download (and may be originally stored in a compressed or installable format that requires installation, decompression, or decryption prior to execution) that may then be stored on a computer readable storage medium. Such computer readable program instructions may be stored, partially or fully, on a memory device (e.g., a computer readable storage medium) of the executing computing device, for execution by the computing device. The computer readable program instructions may execute entirely on a user's computer (e.g., the executing computing device), partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, such as a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart(s) and/or block diagram(s) block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks. For example, the instructions may initially be carried on a magnetic disk or solid state drive of a remote computer. The remote computer may load the instructions and/or modules into its dynamic memory and send the instructions over a telephone, cable, or optical line using a modem. A modem local to a server computing system may receive the data on the telephone/cable/optical line and use a converter device including the appropriate circuitry to place the data on a bus. The bus may carry the data to a memory, from which a processor may retrieve and execute the instructions. The instructions received by the memory may optionally be stored on a storage device (e.g., a solid state drive) either before or after execution by the computer processor.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. In addition, certain blocks may be omitted in some implementations. The methods and processes described herein are also not limited to any particular sequence, and the blocks or states relating thereto can be performed in other sequences that are appropriate.

Each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. For example, any of the processes, methods, algorithms, elements, blocks, applications, or other functionality (or portions of functionality) described in the preceding sections may be embodied in, and/or fully or partially automated via, electronic hardware such application-specific processors (e.g., application-specific integrated circuits (ASICs)), programmable processors (e.g., field programmable gate arrays (FPGAs)), application-specific circuitry, and/or the like (any of which may also combine custom hard-wired logic, logic circuits, ASICs, FPGAs, etc. with custom programming/execution of software instructions to accomplish the techniques).

Any of the above-mentioned processors, and/or devices incorporating any of the above-mentioned processors, may be referred to herein as, for example, “computers,” “computer devices,” “computing devices,” “hardware computing devices,” “hardware processors,” “processing units,” and/or the like. Computing devices of the above-embodiments may generally (but not necessarily) be controlled and/or coordinated by operating system software, such as Mac OS, iOS, Android, Chrome OS, Windows OS (e.g., Windows XP, Windows Vista, Windows 7, Windows 8, Windows 10, Windows Server, etc.), Windows CE, Unix, Linux, SunOS, Solaris, Blackberry OS, VxWorks, or other suitable operating systems. In other embodiments, the computing devices may be controlled by a proprietary operating system. Conventional operating systems control and schedule computer processes for execution, perform memory management, provide file system, networking, I/O services, and provide a user interface functionality, such as a graphical user interface (“GUI”), among other things.

As described above, in various embodiments certain functionality may be accessible by a user through a web-based viewer (such as a web browser), or other suitable software program. In such implementations, the user interface may be generated by a server computing system and transmitted to a web browser of the user (e.g., running on the user's computing system). Alternatively, data (e.g., user interface data) necessary for generating the user interface may be provided by the server computing system to the browser, where the user interface may be generated (e.g., the user interface data may be executed by a browser accessing a web service and may be configured to render the user interfaces based on the user interface data). The user may then interact with the user interface through the web-browser. User interfaces of certain implementations may be accessible through one or more dedicated software applications. In certain embodiments, one or more of the computing devices and/or systems of the disclosure may include mobile computing devices, and user interfaces may be accessible through such mobile computing devices (for example, smartphones and/or tablets).

Many variations and modifications may be made to the above-described embodiments, the elements of which are to be understood as being among other acceptable examples. All such modifications and variations are included within the scope of this disclosure. The foregoing description details certain embodiments. No matter how detailed the foregoing appears in text, the systems and methods can be practiced in many ways. As is also stated above, use of particular terminology when describing certain features or aspects of the systems and methods should not be taken to imply that the terminology is being re-defined herein to be restricted to including any specific characteristics of the features or aspects of the systems and methods with which that terminology is associated.

Conditional language, such as, among others, “can,” “could,” “might,” or “may,” unless specifically stated otherwise, or otherwise understood within the context as used, is generally intended to convey that certain embodiments include, while other embodiments may not include, certain features, elements, and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

The term “substantially” when used in conjunction with the term “real-time” forms a phrase that will be readily understood by a person of ordinary skill in the art. For example, it is readily understood that such language will include speeds in which no or little delay or waiting is discernible, or where such delay is sufficiently short so as not to be disruptive, irritating, or otherwise vexing to a user.

Conjunctive language such as the phrase “at least one of X, Y, and Z,” or “at least one of X, Y, or Z,” unless specifically stated otherwise, is to be understood with the context as used in general to convey that an item, term, etc. may be either X, Y, or Z, or a combination thereof. For example, the term “or” is used in its inclusive sense (and not in its exclusive sense) so that when used, for example, to connect a list of elements, the term “or” means one, some, or all of the elements in the list. Thus, such conjunctive language is not generally intended to imply that certain embodiments require at least one of X, at least one of Y, and at least one of Z to each be present.

The term “a” as used herein should be given an inclusive rather than exclusive interpretation. For example, unless specifically noted, the term “a” should not be understood to mean “exactly one” or “one and only one”; instead, the term “a” means “one or more” or “at least one,” whether used in the claims or elsewhere in the specification and regardless of uses of quantifiers such as “at least one,” “one or more,” or “a plurality” elsewhere in the claims or specification.

The term “comprising” as used herein should be given an inclusive rather than exclusive interpretation. For example, a general purpose computer comprising one or more processors should not be interpreted as excluding other computer components, and may possibly include such components as memory, input/output devices, and/or network interfaces, among others.

While the above detailed description has shown, described, and pointed out novel features as applied to various embodiments, various omissions, substitutions, and changes in the form and details of the devices or processes illustrated may be made without departing from the spirit of the disclosure. Certain embodiments of the inventions described herein may be embodied within a form that does not provide all of the features and benefits set forth herein, as some features may be used or practiced separately from others. The scope of certain inventions disclosed herein is indicated by the appended claims rather than by the foregoing description. All changes which come within the meaning and range of equivalency of the claims are to be embraced within their scope.

What is claimed is:

1. A computing system comprising:
a hardware computer processor;
a non-transitory computer readable medium having software instructions stored thereon, the software instructions executable by the hardware computer processor to cause the computing system to perform operations comprising:
determining an interpreter for a user, the interpreter comprising one or more individuals certified or qualified to interpret between a first language and a second language;
transmitting information to each of an interpreter device of the determined interpreter and a user device of the user,
wherein the transmitted information is usable to initiate a HIPAA compliant direct communication channel between the interpreter device and the user device using a third-party communication service,
wherein the direct communication channel is not accessible by the computing system;
receiving one or more interpreting service start time from the interpreter and/or the user that are usable in determination of a call duration of a call between the interpreter and the user via the HIPAA compliant direct communication channel;
receiving one or more interpreting service end time from the interpreter and/or the user that are usable in determination of the call duration; and
determining the call duration based at least on:
one or more of the interpreting service start times; and
one or more of the interpreting service end times.

2. The computing system of claim 1, wherein the first language is English and the second language is a non-English language.

3. The computing system of claim 1, wherein the first language is sign language and the second language is verbal English.

4. The computing system of claim 1, wherein the direct communication channel comprises a voice and/or video communication channel.

5. The computing system of claim 1, further comprising:
receiving, from the third-party communication service, third-party call information including one or more of a third-party start time, a third-party end time, and a third-party call duration;
wherein the call duration is further based on the third-party call information.

6. The computing system of claim 1, wherein the call duration is based on an interpreting service start time from the interpreter and/or the user, and an interpreting service end time from the interpreter and/or the user.

7. A computerized method, performed by a computing system having one or more hardware computer processors and one or more non-transitory computer readable storage device storing software instructions executable by the computing system to perform the computerized method comprising:
providing an application to a user device and to an interpreter device, wherein the application is a standalone-application or a browser-based application;
receiving, via the application running on the user device, an interpretation request including an indication of a requested language;
accessing an interpreter database indicating a plurality of interpreters and associated languages spoken by each of the plurality of interpreters;
identifying an interpreter of the plurality of interpreters as matching the interpretation request at least based on association of the interpreter with the requested language in the interpreter database;
providing an interactive user-interface function enabling communication of a communication link between the user device and the interpreter device of the identified interpreter, wherein the communication link is associated with a third-party communication service and is usable to establish a direct communication channel between the user device and the interpreter device;
receiving one or more interpreting service start time from the interpreter and/or the user that are usable in determination of a call duration of a call between the interpreter and the user via the HIPAA compliant direct communication channel; and
receiving one or more interpreting service end time from the interpreter and/or the user that are usable in determination of the call duration.

8. The computerized method of claim 7, wherein the communication link includes a personal meeting ID of the user, and wherein the communication link is transmitted from the user device to the interpreter device via the communication functionality of the application.

9. The computerized method of claim 7, wherein the communication link includes a personal meeting ID of the interpreter, and wherein the communication link is transmitted from the interpreter device or the interpreting system to the user device via the communication functionality of the application.

10. The computerized method of claim 7, wherein the communication link includes a meeting ID generated by the third-party communication service.

11. The computerized method of claim 7, wherein the communication link includes a telephone number.

12. The computerized method of claim 7, wherein the spoken languages include sign language.

13. The computerized method of claim 7, further comprising:
determining the call duration based at least on:
one or more of the interpreting service start times; and
one or more of the interpreting service end times.

14. The computerized method of claim 7, wherein the interpreter device is configured to execute the application on the interpreter device to:
send information to and receive information from the application executing on the user device;
receive input, via a graphical user interface of the application, indicating the interpreting service start time from the interpreter;
receive input, via the graphical user interface of the application, indicating the interpreting service end time from the interpreter; and
transmit, to the computing system, one or more of the interpreting service start time and the interpreting service end time.

15. The computerized method of claim 7, wherein the user device is configured to execute the application on the user device to:
send information to and receive information from the application executing on the interpreter device;
receive input, via a graphical user interface of the application, indicating the interpreting service start time from the user;
receive input, via the graphical user interface of the application, indicating the interpreting service end time from the user; and
transmit, to the computing system, one or more of the interpreting service start time and the interpreting service end time.

16. The computerized method of claim 7, wherein the direct communication channel is provided via a video conferencing application, an audio conferencing application, or a phone system.

17. The computerized method of claim 7, wherein, the third-party communication service is provided via a communication application downloadable from an application store on a smartphone or smart device.
